(19) United States
(12) Patent Application Publication
(10) Pub. No.: US 2025/0252173 A1
(43) Pub. Date: Aug. 7, 2025

(54) MULTI FACTOR CONTEXT BASED VEHICLE SECURITY

(71) Applicant: Toyota Motor Engineering & Manufacturing North America, Inc., Plano, TX (US)

(72) Inventors: Rohit Gupta, Santa Clara, CA (US); Akila C. Ganlath, San Jose, CA (US); Roger Melen, Los Altos Hills, CA (US); Nejib Ammar, San Jose, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/432,429

(22) Filed: Feb. 5, 2024

(51) Int. Cl. G06F 21/40; G07C 9/00

(52) U.S. Cl. CPC G06F 21/40; G07C 9/00309; G07C 9/00563; G07C 2009/00984

(57) ABSTRACT

A method may include receiving, at a vehicle system of a vehicle, a plurality of sets of data associated with a user, performing validations of each set of the plurality of sets of data to achieve multi-factor authentication of the user, determining whether one or more validations are unable to be performed, and upon determination that one or more validations are unable to be performed, recommending one or more alternative validations methods to achieve multi-factor authentication of the user.

### TECHNICAL FIELD

The present specification relates to vehicle security, and more particularly to multifactor context based vehicle security.

### BACKGROUND

Vehicle theft is a significant problem. One way to reduce vehicle theft is for a vehicle system to authenticate a user before access to the vehicle is granted. In particular, multifactor authentication may be used to increase vehicle security. However, requiring the same type of multifactor authentication in all situations may be overly burdensome on vehicle owners. Accordingly, a need exists for multifactor context based vehicle security.

### SUMMARY

In an embodiment, a method may include receiving, at a vehicle system of a vehicle, a plurality of sets of data associated with a user, performing validations of each set of the plurality of sets of data to achieve multi-factor authentication of the user, determining whether one or more validations are unable to be performed, and upon determination that one or more validations are unable to be performed, recommending one or more alternative validations methods to achieve multi-factor authentication of the user.

In another embodiment, a vehicle may include a processor. The processor may receive a plurality of sets of data associated with a user, perform validations of each set of the plurality of sets of data to achieve multi-factor authentication of the user, determine whether one or more validations are unable to be performed, and upon determination that one or more validations are unable to be performed, recommend one or more alternative validations methods to achieve multi-factor authentication of the user.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for multi factor context based vehicle security, according to one or more embodiments shown and described herein;

FIG. 2 depicts a schematic diagram of a vehicle system, according to one or more embodiments shown and described herein;

FIG. 3 depicts a schematic diagram of memory modules of the vehicle system of FIG. 2, according to one or more embodiments shown and described herein;

FIG. 4 shows a flowchart of a method of operating the vehicle system of FIG. 2, according to one or more embodiments shown and described herein; and

FIG. 5 depicts a flowchart of another method of operating the vehicle system of FIG. 2, according to one or more embodiments shown and described herein.

### DETAILED DESCRIPTION

The embodiments disclosed herein describe a method and system for performing multifactor authentication for vehicles. In particular, a vehicle system may include one or more sensors that authenticate a user before allowing access to the vehicle. As such, access to the vehicle may be restricted, thereby increasing vehicle security. In addition, the vehicle system may allow different users different levels of access to the vehicle. This may allow a user to grant different levels of access to third parties, as disclosed herein. For example, a user may allow a valet driver limited driving capabilities to park a vehicle, or may allow a delivery driver access to the vehicle's trunk to place a package without allowing access to drive the vehicle.

In addition, the vehicle system may require multifactor authentication. That is, the vehicle system may require more than one type of authentication before access to the vehicle is granted. However, requiring multifactor authentication may inconvenience a user by requiring the user to carry additional items, remember additional passwords, or perform additional procedures to access the vehicle. While this may be desirable in certain situations, in order to increase security of the vehicle, there may be other situations where this heightened level of security is not desirable. For example, when the vehicle is near the user's home, a lower level of security may be acceptable. Accordingly, as disclosed herein, a vehicle system may require different levels of multifactor authentication depending on where the vehicle is located or other factors.

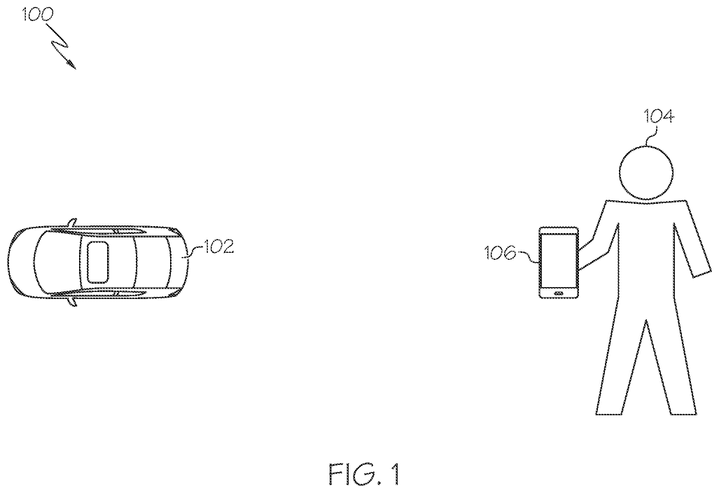

Turning now to the figures, FIG. 1 schematically depicts a system for multifactor context based vehicle security. In the example of FIG. 1, a system 100 includes a vehicle 102, a user 104, and a smartphone 106.

In the example of FIG. 1, the vehicle 102 is an automobile. However, in other examples, the vehicle 102 may be any other type of vehicle. In the example of FIG. 1, the vehicle 102 may be communicatively coupled to the smartphone 106, as disclosed herein.

The user 104 may be the owner or user of the vehicle 102. The user 104 may carry the smartphone 106. The user 104 may use the smartphone 106 to set authentication parameters for the vehicle 102, as disclosed herein. While the user in the example of FIG. 1 uses the smartphone 106 to set authentication parameters for the vehicle 102, in other examples, the user 104 may use other computing devices to set authentication parameters for the vehicle 102 (e.g., a desktop computer, a laptop computer, a table, a dedicated hardware device, a key fob and the like).

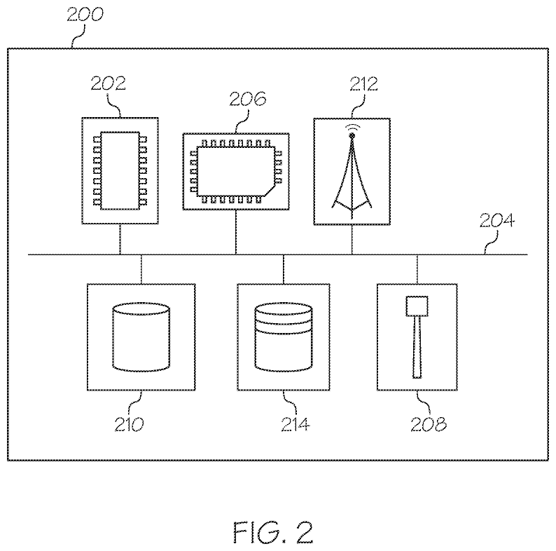

FIG. 2 depicts an example vehicle system 200 that may be included in the vehicle 102 of FIG. 1. In the example of FIG. 2, the vehicle system 200 includes one or more processors 202, a communication path 204, one or more memory modules 206, a satellite antenna 208, one or more vehicle sensors 210, a network interface hardware 212, and a data storage component 214, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may be used to authenticate a user. In particular, the vehicle sensors 210 may include, but are not limited, to, a video or still image camera, a microphone, a fingerprint scanner, a driver's license scanner, a key fob detector, and the like. The vehicle sensors 210 may also determine information about the vehicle 102 such as a gasoline amount, an electrical charge level, and the like.

Still referring to FIG. 2, the vehicle system 200 comprises network interface hardware 212 for communicatively coupling the vehicle system 200 to the smartphone 106 and/or other computing devices. The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol.

Still referring to FIG. 2, the vehicle system 200 comprises a data storage component 214. The data storage component 214 may store data used by various components of the vehicle system 200. In particular, the data storage component 214 may store information to be used to authenticate users. For example, authentication information may be preregistered with the vehicle system 200 for one or more information. This information may include passwords, fingerprint data, images of users' faces, voiceprints of users, and the like. In addition, the data storage component 214 may store data received from the smartphone 106, as discussed in further detail below.

In some embodiments, the vehicle system 200 may be communicatively coupled to the smartphone 106 by a network. In one embodiment, the network may include one or more computer networks (e.g., a personal area network, a local area network, or a wide area network), cellular networks, satellite networks and/or a global positioning system and combinations thereof. Accordingly, the vehicle system 200 can be communicatively coupled to the network via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

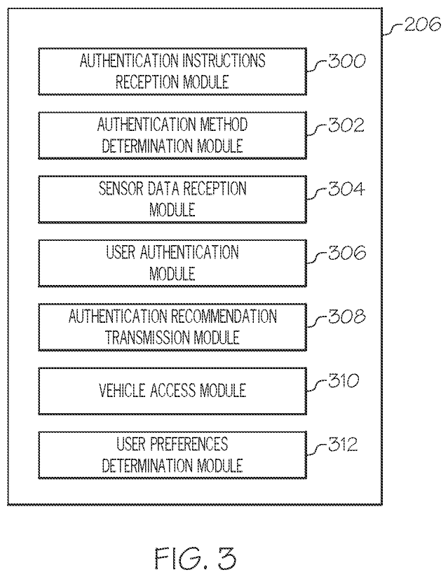

Now referring to FIG. 3, the one or more memory modules 206 are schematically shown. The one or more memory modules 206 include an authentication instructions reception module 300, an authentication method determination module 302, a sensor data reception module 304, a user authentication module 306, an authentication recommendation transmission module 308, a vehicle access module 310, and a user preferences determination module 312. Each of the authentication instructions reception module 300, the authentication method determination module 302, the sensor data reception module 304, the user authentication module 306, the authentication recommendation transmission module 308, the vehicle access module 310, and the user preferences determination module 312 may be a program module in the form of operating systems, application program modules, and other program modules stored in the one or more memory modules 206. Such a program module may include, but is not limited to, routines, subroutines, programs, objects, components, data structures and the like for performing specific tasks or executing specific data types as will be described below.

The authentication instructions reception module 300 may receive instructions for authenticating a user prior to allowing access to the vehicle 102. In some examples, the authentication instructions reception module 300 may receive such instructions from the smartphone 106 after being input by the user 104. In other examples, the instructions may be received from other devices.

The instructions received by the authentication instructions reception module 300 may specify instructions as to how a user can be authenticated and be given access to the vehicle 102. Authenticating the user may comprise determining that an individual attempting to access the vehicle 102 is authorized to access the vehicle 102. Typically, access to a vehicle is granted by carrying a key or a key fob. However, in order to decrease vehicle theft and vandalism, and other increase vehicle security, multi-factor authentication may be used. That is, access to a vehicle may require multiple types of authentication. As such, if one type of authentication is compromised, other authentication factors may still prevent unauthorized access.

The instructions received by the authentication instructions reception module 300 may specify the number and/or type of different types of authentication required to access the vehicle 102. Different authentication types that may be used to access the vehicle 102 may include, but are not limited to, detecting the presence of a key or key fob, capturing an image of a user's face, capturing a user's fingerprints, capturing a user's voice, detecting a user's smartphone or other handheld device, detecting a user's gait, scanning a driver's license or other identification, and the like. Authentication may be performed based on data captured by the sensors 210, as discussed in further detail below.

The user 104 may specify the types of authentication required to access the vehicle 102 using the smartphone 106. In some examples, the user 104 may specify the specific types of authentication required to access the vehicle 102. In some examples, the user 104 may simply specify the number of authentications required to access the vehicle 102, rather than the specific types of authentication required. In some examples, the user 104 may specify a different number and/or different types of authentications required for different locations of the vehicle 102. For example, if the vehicle 102 is located in a safe location (e.g., near the home of the user 104), a single authentication method may be required. However, if the vehicle 102 is located in an unsafe or unknown location, multiple authentication methods may be required. As such, security of the vehicle 102 may be increased when it is located in an unsafe or unknown location.

In some examples, the user 104 may specify different types of access to the vehicle 102 associated with different authentications. This may allow the user 104 to grant friends, family members, or other third parties limited access to the vehicle. For example, the user 104 may want to allow another individual to take something out of the trunk, without that individual being able to drive the vehicle. Accordingly, the user 104 may use the smartphone 106 to specify that this individual is allowed access to the trunk. Accordingly, the authentication instructions reception module 300 may receive instructions that when this particular individual is authenticated, the trunk is unlocked but other doors remain locked and other vehicle functionality is not allowed. As such, this individual may approach the vehicle 102 and be authenticated (e.g., by using their smartphone, facial recognition, or the like). Once the individual is authenticated, the trunk may be unlocked. In some examples, registration information associated with certain individuals may be stored in the data storage component 214 (e.g., images to use for facial recognition, smartphone data, and the like).

Other types of limited access to the vehicle 102 may include, but is not limited to, unlocking one or more doors of the vehicle 102, allowing use of the radio of the vehicle 102, or allowing use of the heating or air conditioning, and the like. In some examples, the user 104 may allow certain individuals limited access to drive the vehicle. For example, the user 104 may want to allow a valet driver to park the vehicle 102. As such, the user 104 may specify a limited distance that certain individuals are allowed to drive the vehicle 102 after being authenticated or a maximum speed that the vehicle 102 may be driven.

In some examples, rather than specifying access permissions for particular individuals, the user 104 may specify access to a company or organization. For example, the user 104 may wish to allow a delivery company access to the trunk of the vehicle 102 so that a package may be placed in the trunk rather than being left outside. As such, the user 104 may grant access to the trunk of the vehicle 102 for a particular delivery company. This delivery company may have a particular access code or other authentication information that their employees may use to be authenticated by the vehicle system 200.

The authentication method determination module 302 may determine the types of authentication required in a particular situation based on the instructions received by the authentication instructions reception module 300. As discussed above, the instructions received by the authentication instructions reception module 300 may specify the number and/or types of authentication required for different users, different vehicle locations, or other situations. As such, the authentication method determination module 302 may determine the types of authentication required for a particular situation.

In some examples, different authentications may be required for different users (e.g., third parties may require different types of authentication than the user 104). In these examples, the authentication method determination module 302 may determine the types of authentication required based upon the individual attempting to be authenticated. In some examples, different types of authentication may be required based on the location of the vehicle 102 (e.g., unsafe or unknown locations may require more types of authentication than safe locations). In these examples, the authentication method determination module 302 may determine the location of the vehicle based on data received by the satellite antenna 208, and may then determine the appropriate types of authentication based on the determined location.

In some examples, the instructions received by the authentication instructions reception module 300 may indicate other factors that may influence the types of authentication required to authenticate a user. For example, different types of authentication may be required based on an amount of gas in a gas-powered vehicle, an electrical charge level of an electric vehicle, a date or time of day, and other factors. As such, the authentication method determination module 302 may gather the appropriate data from the sensors 210 to determine the types of authentication required based on a particular situation when an authentication is requested.

The sensor data reception module 304 may receive data from the sensors 210 to be used to authenticate an individual. In particular, the sensor data reception module 304 may receive data associated with one or more types of authentication determined by the authentication method determination module 302. For example, if facial recognition is one of the types of authentication specified by the authentication method determination module 302, then the sensor data reception module 304 may receive an image of a user's face captured by an external camera. If fingerprints are specified as an authentication type by the authentication method determination module 302, then the sensor data reception module 304 may receive data from a fingerprint scanner. If gait is one of the types of authentication specified by the authentication method determination module 302, then the sensor data reception module 304 may record a video of a user captured by an external camera and process the video to identify the user's gait. As such, the appropriate data for authenticating an individual may be received by the sensor data reception module 304.

The user authentication module 306 may authenticate an individual based on the authentication types specified by the authentication method determination module 302 and the data received by the sensor data reception module 304. In particular, the user authentication module 306 may validate data received by the sensor data reception module 304. That is, the user authentication module 306 may ensure that data received by the sensor data reception module 304 matches expected data (e.g., that a password is correct or that an image of a user's face matches a stored image of the user's face).

In some examples, the user authentication module 306 may validate data received by the sensor data reception module 304 by comparing the received data to authentication data stored on the data storage component 214. For example, the authentication method determination module 302 may determine that one type of authentication to be performed is a driver's license scan. In this example, the sensor data reception module 304 may capture an image of an individual's driver's license (e.g., the individual may hold the driver's license in front of an external vehicle camera). The user authentication module 306 may then compare the captured image of the individual's driver's license to a stored image of the driver's license and determine if they match. If the captured sensor data matches pre-stored authentication information, the user authentication module 306 may determine that the driver's license has been validated and that this particular type of authentication has been satisfied. If the data associated with all of the authentication types specified by the authentication method determination module 302 for a particular user are validated, the user authentication module 306 may determine that the user is authenticated.

The authentication recommendation transmission module 308 may recommend additional or different authentication methods if one or more authentication methods specified by the authentication method determination module 302 cannot be performed or properly completed. For example, in bad weather, a satisfactory image of a user may not be able to be taken to authenticate a user based on the user's face. Or a sensor needed for a particular authentication method may be damaged. This may prevent all of the authentication methods specified by the authentication method determination module 302 from being performed. As such, in order to achieve the appropriate level of multi-factor authentication, one or more alternative authentication methods may be recommended by the authentication recommendation transmission module 308.

For example, the authentication method determination module 302 may specify detection of a key fob and facial recognition as two methods of authentication for the user 104. However, in poor weather conditions, the user authentication module 306 may only be able to detect the key fob and may not be able to perform facial recognition. The authentication method determination module 302 may obtain current weather information from the internet based on the location information of the vehicle. In this circumstance, the authentication recommendation transmission module 308 may recommend an alternative authentication method in order to ensure that two different authentications are performed before authenticating the user 104. For example, the authentication recommendation transmission module 308 may recommend voice recognition as an alternative authentication method. In some examples, the authentication recommendation transmission module 308 may determine an alternative authentication method based on a preselected list of potential alternative authentication methods. In other examples, the authentication recommendation transmission module 308 may determine alternative authentication methods using other techniques.

In some examples, the authentication recommendation transmission module 308 may transmit a message indicating a recommended alternative authentication method to the smartphone 106. The user 104 may then see the recommended alternative authentication method on the smartphone 106 and may perform the steps necessary for the alternative authentication method (e.g., speaking into a microphone such that voice recognition can be performed). In other examples, the authentication recommendation transmission module 308 may cause the recommended alternative authentication method to be displayed on an external display on the vehicle 102 or audibly output from speakers such that a user will become aware of the recommended alternative authentication method. The user may then perform whatever actions are necessary for the alternative authentication method such that multi-factor authentication may be implemented.

The vehicle access module 310 may grant access to one or more vehicle functions. In particular, after the user authentication module 306 has authenticated a particular user, the vehicle access module 310 may grant vehicle access to that user in accordance with the instructions received by the authentication instructions reception module 300. The vehicle access module 310 may grant vehicle access including, but not limited to, unlocking one or more vehicle doors, unlocking the trunk, allowing the vehicle to be started, allowing the vehicle's radio to used, allowing the vehicle's heating or air conditioning to be used, allowing vehicle lights to be turned on, or allowing the vehicle to be driven with or without restriction (e.g., for a certain time period or within a certain distance).

The user preferences determination module 312 may determine authentication methods preferred by the user 104, as disclosed herein. In particular, the user 104 may interact with the vehicle 102 a number of times over a period of time and may specify a preferred set of authentication methods each time. Over time, the user 104 may tend to specify the same authentication methods many times. As such, the user preferences determination module 312 may learn the preferred authentication methods associated with the user 104 over time (e.g., the most commonly selected authentication methods specified by the user 104). These preferred authentication methods may be stored in the data storage component 214. In some examples, the vehicle system 200 may set the preferred authentication methods as a set of default authentication methods for multi-factor authentication associated with the user 104. As such, in some examples, if the user 104 does not send instructions for multi-factor authentication for the vehicle 102, the default authentication methods may be used to achieve multi-factor authentication.

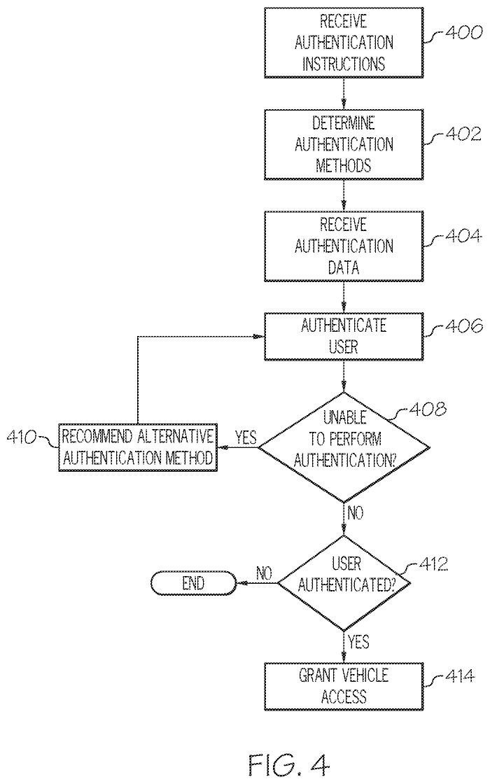

FIG. 4 depicts a flowchart of an example method for operating the vehicle system 200 to perform multi-factor authentication. At step 400, the authentication instructions reception module 300 receives authentication instructions from the smartphone 106. In particular, the authentication instructions may indicate a set of authentication methods required to perform multi-factor authentication to authenticate one or more individuals, and the types of vehicle access to be granted after the one or more individuals are authenticated.

At step 402, the authentication method determination module 302 determines authentication methods needed to authenticate a particular user. In particular, the authentication method determination module 302 may determine the authentication methods based on the instructions received by the authentication instructions reception module 300 and particular circumstances associated with the vehicle 102 (e.g., the location of the vehicle 102, the time of day, and the like).

At step 404, the sensor data reception module 304 receives authentication data associated with an individual to be authenticated. In particular, the sensor data reception module 304 may receive authentication date from the vehicle sensors 210 needed to perform the authentication methods determined by the authentication method determination module 302 (e.g., an image of the individual to be authenticated, an image of a driver's license, audio spoken by the individual, smartphone data, and the like).

At step 406, the user authentication module 306 attempts to authenticate the individual to be authenticated. In particular, the individual performs the authentication methods determined by the authentication method determination module 302 by validating the data received by the sensor data reception module 304.

At step 408, the user authentication module 306 determines whether one or more authentication methods determined by the authentication method determination module 302 are unable to be performed. For example, in poor weather, it may not be possible to capture an image of the individual's face that is high enough quality to perform facial recognition, or signal connectivity may not be sufficient to receive data from a smartphone. As another example, it may not be able to accurately identify an individual's face in dark environment. For example, the current time is after sunset or before sunrise, it may not be possible to capture an image of the individual's face that is high enough quality to perform facial recognition.

If the user authentication module 306 determines that one or more authentication methods are unable to be performed (Yes at step 408), then at step 410, the authentication recommendation transmission module 308 recommends an alternative authentication method, and control returns to step 408. Alternatively, if the user authentication module 306 determines that all of the specified authentication methods are able to be performed (No at step 408), then control passes to step 412.

At step 412, the user authentication module 306 determines whether the individual requesting authentication has been authenticated. If the individual is authenticated (Yes at step 412), then at step 414, the vehicle access module 310 grants the appropriate level of vehicle access to the individual based on the instructions received by the authentication instructions reception module 300. Alternatively, if the individual is not authenticated (No at step 412), then the method of FIG. 4 ends.

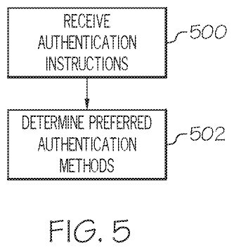

FIG. 5 depicts a flowchart of an example method for operating the vehicle system 200 to learn preferred authentication methods for the user 104. At step 500, the authentication instructions reception module 300 receives authentication instructions from the smartphone 106 specified by the user 104. In particular, the user 104 may specify a set of authentication methods for performing multi-factor authentication in a particular instance. Over time, the authentication instructions reception module 300 may receive a set of authentication methods many different times. Each time that a set of authentication methods is received, a record of those specified authentication methods may be stored in the data storage component 214.

Then, at step 502, the user preferences determination module 312 may determine a set of authentication methods preferred by the user 104 for performing multi-factor authentication based on the instructions received by the authentication instructions reception module 300 over time. In one example, the user preferences determination module 312 may determine the most frequently selected set of authentication methods specified by the user 104. In other examples, the user preferences determination module 312 may use other techniques to determine the authentication methods preferred by the user 104 for performing multi-factor authentication.

It should now be understood that the embodiments described herein are directed to multifactor context based vehicle security. In particular, multi-factor authentication may be utilized to grant a user access to a vehicle. Different users may be granted different levels of vehicle access for particular purposes. As such, a vehicle owner may grant limited vehicle access to various third parties for different purposes. In addition, if a particular authentication method cannot be performed, additional authentication methods can be suggested. This may ensure that multi-factor authentication can still be performed, even when certain methods of authentication are unable to be performed for various reasons. This may increase vehicle security. In addition, by allowing a user to specify preferred authentication methods for multi-factor authentication, user convenience may be increased.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, at a vehicle system of a vehicle, a plurality of sets of data associated with a user;
performing validations of each set of the plurality of sets of data to achieve multi-factor authentication of the user;
determining whether one or more validations are unable to be performed; and
upon determination that one or more validations are unable to be performed, recommending one or more alternative validations methods to achieve multi-factor authentication of the user.

2. The method of claim 1, further comprising:
receiving a first set of authentication methods to be performed to achieve multi-factor authentication of the user, each authentication method comprises validating a set of data associated with the user; and
receiving the plurality of sets of data associated with the first set of authentication methods.

3. The method of claim 2, further comprising:
receiving additional sets of authentication methods to be performed to achieve multi-factor authentication of the user over a first period of time; and
determining a preferred set of authentication methods to be performed to achieve multi-factor authentication of the user based on the first set of authentication methods and the additional sets of authentication methods.

4. The method of claim 1, further comprising, upon validation of each set of the plurality of sets of data, granting access to one or more features of the vehicle.

5. The method of claim 1, further comprising:
receiving a first set of features associated with the vehicle for which access is to be granted to the user after the user is authenticated; and
upon validation of each set of the plurality of sets of data, granting access to the first set of features associated with the vehicle.

6. The method of claim 5, wherein at least one of the first set of features comprises unlocking one or more doors of the vehicle.

7. The method of claim 5, wherein at least one of the first set of features comprises unlocking a trunk of the vehicle.

8. The method of claim 5, wherein at least one of the first set of features comprises allowing the vehicle to be driven.

9. The method of claim 1, further comprising determining at least one set of data to be validated based on a location of the vehicle.

10. The method of claim 1, further comprising determining at least one set of data to be validated based on a charge level of a battery of the vehicle.

11. A vehicle comprising a processor configured to:
receive a plurality of sets of data associated with a user;
perform validations of each set of the plurality of sets of data to achieve multi-factor authentication of the user;
determine whether one or more validations are unable to be performed; and
upon determination that one or more validations are unable to be performed, recommend one or more alternative validations methods to achieve multi-factor authentication of the user.

12. The vehicle of claim 11, wherein the processor is further configured to:
receive a first set of authentication methods to be performed to achieve multi-factor authentication of the user, each authentication method comprises validating a set of data associated with the user; and
receive the plurality of sets of data associated with the first set of authentication methods.

13. The vehicle of claim 12, wherein the processor is further configured to:
receive additional sets of authentication methods to be performed to achieve multi-factor authentication of the user over a first period of time; and
determine a preferred set of authentication methods to be performed to achieve multi-factor authentication of the user based on the first set of authentication methods and the additional sets of authentication methods.

14. The vehicle of claim 11, wherein the processor is further configured to, upon validation of each set of the plurality of sets of data, grant access to one or more features of the vehicle.

15. The vehicle of claim 11, wherein the processor is further configured to:
receive a first set of features associated with the vehicle for which access is to be granted to the user after the user is authenticated; and
upon validation of each set of the plurality of sets of data, grant access to the first set of features associated with the vehicle.

16. The vehicle of claim 15, wherein at least one of the first set of features comprises unlocking one or more doors of the vehicle.

17. The vehicle of claim 15, wherein at least one of the first set of features comprises unlocking a trunk of the vehicle.

18. The vehicle of claim 15, wherein at least one of the first set of features comprises allowing the vehicle to be driven.

19. The vehicle of claim 11, wherein the processor is further configured to determine at least one set of data to be validated based on a location of the vehicle.

20. The vehicle of claim 11, wherein the processor is further configured to determine at least one set of data to be validated based on a charge level of a battery of the vehicle.
